(19) United States
(12) Patent Application Publication
(10) Pub. No.: US 2026/0089112 A1
(43) Pub. Date: Mar. 26, 2026

(54) SYSTEMS AND METHODS FACILITATING USER LEVEL TRAFFIC TYPE CLASSIFICATION IN PACKET DATA NETWORKS FOR NETWORK RESOURCE OPTIMIZATION IN OPEN RADIO ACCESS NETWORKS

(71) Applicant: AT&T Intellectual Property I, L.P., Atlanta, GA (US)

(72) Inventors: Yuan Ding, Plainsboro, NJ (US); Vinay Sharma, Queens Village, NY (US); Junping Zhang, Freehold, NJ (US); Joseph Dahan, Redmond, WA (US); Tzvi Chumash, Matawan, NJ (US)

(73) Assignee: AT&T Intellectual Property I, L.P., Atlanta, GA (US)

(21) Appl. No.: 18/891,445

(22) Filed: Sep. 20, 2024

(51) Int. Cl. H04L 47/2441; H04L 41/0823; H04L 47/2475

(52) U.S. Cl. CPC H04L 47/2441; H04L 41/0823; H04L 47/2475

(57) ABSTRACT

Aspects of the subject disclosure may include, for example, acquiring data traffic from an open radio unit network (ORAN) with respect to user equipment (UE) resulting in acquired data traffic; analyzing the acquired data traffic using a rApp deployed therein, the rApp configured as a traffic classification application operable to classify the acquired data traffic into one or more service types; based on the classification of the one or more service types, determining allocation of one or more RAN slices to be optimized for the one or more service types; and transmitting the determined allocation to a near-real-time radio access network intelligent controller (near-RT RIC) to implement the allocation of the one or more RAN slices in one or more open distributed units (O-DUs) and one or more open radio units (O-RUs) in the ORAN. Other embodiments are disclosed.

### FIELD OF THE DISCLOSURE

The subject disclosure relates to systems and methods facilitating user level traffic type classification in packet data networks for network resource optimization in open radio access networks (ORANs).

### BACKGROUND

Network companies face challenges as more and more applications and services are added to networks, which results in growing demands for network traffic. The increased network traffic may slow services down, cause data to get lost, and affect the overall network performance. In addition, a sizable portion of network traffic started getting encrypted. It is getting more difficult for network companies to understand and effectively manage the encrypted network traffic. Without understanding the network traffic and organizing the network traffic accordingly, there may be a limit in utilizing network resources in the most optimal way possible. The quality of service that users experience can be impacted.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A depicts a non-limiting example of user level traffic type classification.

FIG. 2B is a block diagram illustrating an example, non-limiting embodiment of a user level traffic type classification system in accordance with various aspects described herein.

FIG. 2C depicts an illustrative embodiment of a movement type machine learning model in accordance with various aspects described herein.

FIG. 2D depicts an illustrative embodiment of a content type machine learning model in accordance with various aspects described herein.

FIG. 2E is a block diagram illustrating an example, non-limiting embodiment of a system functioning within the communication network of FIG. 1 in accordance with various aspects described herein.

FIG. 2F depicts an illustrative embodiment of network slices optimization in accordance with various aspects described herein.

FIG. 2G depicts an illustrative embodiment of utilizing open standards in a traffic classification system in accordance with various aspects described herein.

FIG. 2H depicts a non-limiting example of the traffic classification system of FIG. 2G in accordance with various aspects described herein.

FIG. 2I is a block diagram illustrating an example, non-limiting embodiment of an open radio access network (ORAN) functioning within the communication network of FIG. 1 in accordance with various aspects described herein.

FIG. 2J depicts an illustrative embodiment of a method in accordance with various aspects described herein.

FIG. 2K depicts an illustrative embodiment of another method in accordance with various aspects described herein.

FIG. 2L depicts an illustrative embodiment of further another method in accordance with various aspects described herein.

FIG. 2M depicts an illustrative embodiment of yet another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systems and methods facilitating user level traffic type classification in packet data networks for network resource optimization in open radio access networks (ORAN). The systems and methods recognize and categorize various types of data usage, thereby allowing for more efficient network resource allocation, improving traffic management, and enhancing user experience. By classifying data traffic at the user level, service providers can better understand usage patterns, prioritize network resources, and potentially offer tailored services based on users' needs. Other embodiments are described in the subject disclosure.

One or more aspects of the subject disclosure are directed to a device including a processing system having a processor and a memory that stores executable instructions that, when executed by the processing system, facilitate performance of operations. The operations include acquiring data traffic from an open radio unit network (ORAN) with respect to user equipment (UE); analyzing the acquired data traffic using a rApp deployed therein, the rApp configured as a traffic classification application operable to classify the acquired data traffic into one or more service types; based on the classification of the one or more service types, determining allocation of one or more RAN slices to be optimized for the one or more service types; and transmitting the determined allocation to a near-real-time radio access network intelligent controller (near-RT RIC) to implement the allocation of the one or more RAN slices in one or more open distributed units (O-DUs) and one or more open radio units (O-RUs) in the ORAN.

One or more aspects of the subject disclosure are directed to a non-transitory machine-readable medium, comprising executable instructions that, when executed by a processing system including a processor, facilitate performance of operations. The operations include receiving, via an O1 interface, data traffic from an open radio unit network (ORAN) with respect to user equipment (UE); classifying the received data traffic into one or more service requirements that are indicative of optimized network resource slices to be allocated; and transmitting, via an A1 interface, the allocation of the network resource slices to a near-real-time radio access network intelligent controller (near-RT RIC) to implement the allocation of the network resource slices in one or more open distributed units (O-DUs) and one or more open radio units (O-RUs) in the ORAN.

One or more aspects of the subject disclosure are directed to a method including acquiring, by a processing system including a processor, real-time data traffic; processing, by the processing system, the real-time data traffic into a comprehensive data set; classifying, by the processing system, the real-time data traffic using a machine learning model based on the comprehensive data set; determining, by the processing system, a network resource slice that optimizes service requirements based on the classification of the real-time data traffic; generating, by the processing system, policies and guidance instructions including association between the classification of the real-time data traffic and the network resource slice; and transmitting, by the processing system, the generated policies and guidance instructions to a near-real-time radio access network intelligent controller to implement the generated policies and guidance instructions.

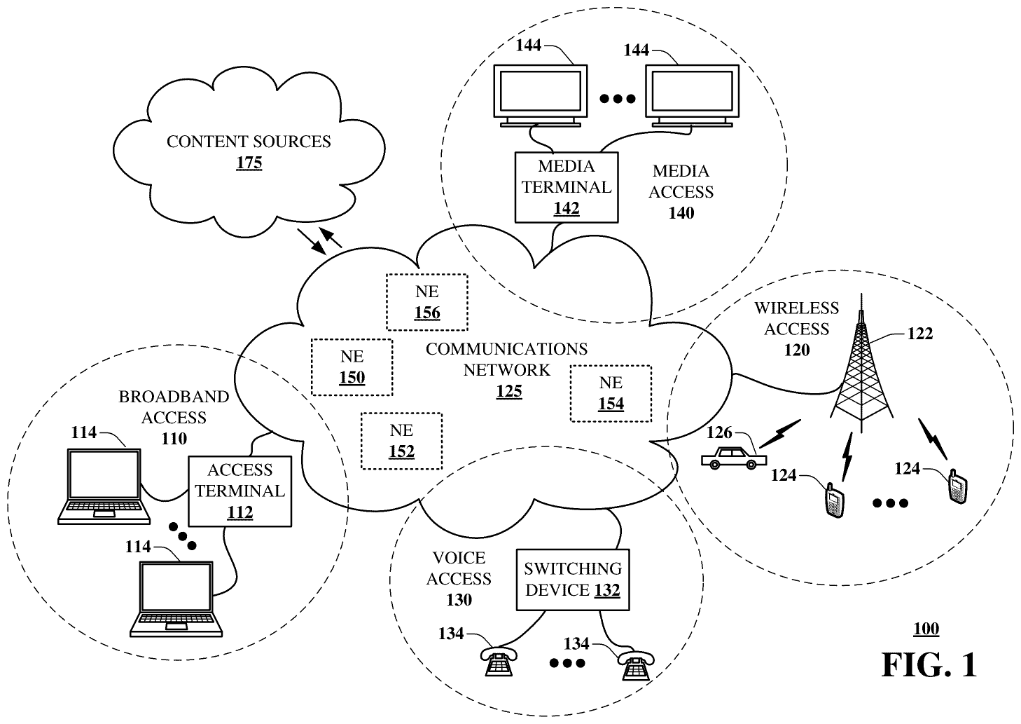

Referring now to FIG. 1, a block diagram is shown illustrating an example, non-limiting embodiment of a system 100 in accordance with various aspects described herein. For example, system 100 can facilitate in whole or in part systems and methods facilitating user level traffic type classification in packet data networks for network resource optimization in ORAN. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

For users' network activities such as streaming movies or playing games, if network companies do not have a good understanding of user traffic, network companies may not offer services that are tailored to individual users' needs. New application and services are ever growing and added to networks, and more of user traffic are subject to encryption. It is difficult for network companies to keep track of the new traffic and the encrypted traffic. This makes it hard for network companies to manage the network traffic and keep it working well. It is desirable to optimize network resources to accommodate user level traffic type classification in packet data networks. Identifying the user level traffic type classification in packet data networks enables network companies to understand and manage network traffic better, even for encrypted traffic.

Network service providers can achieve improved level of user experience.

The subject disclosure is directed to systems and methods for facilitating user level traffic type classification in packet data networks, including and not limited to optimization and slicing in 5G networks. The systems and methods classify user traffic based on specific usage types such as streaming, browsing, gaming and calls, directly from packet-level data. The systems and methods may advance network resource optimization by providing precise, real-time insights into individual user behavior. The systems and methods can recognize and categorize various types of data usage, therefore allowing for more efficient network resource allocation, improved traffic management, and enhanced user experience over fixed and static allocation of network resources. Th systems and methods stand to significantly improve network performance and reliability, particularly in the context of 5G/6G networks where the demand for bandwidth and speed is ever-increasing.

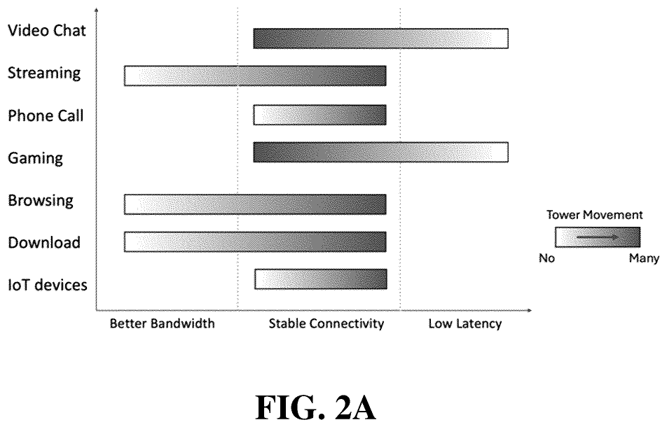

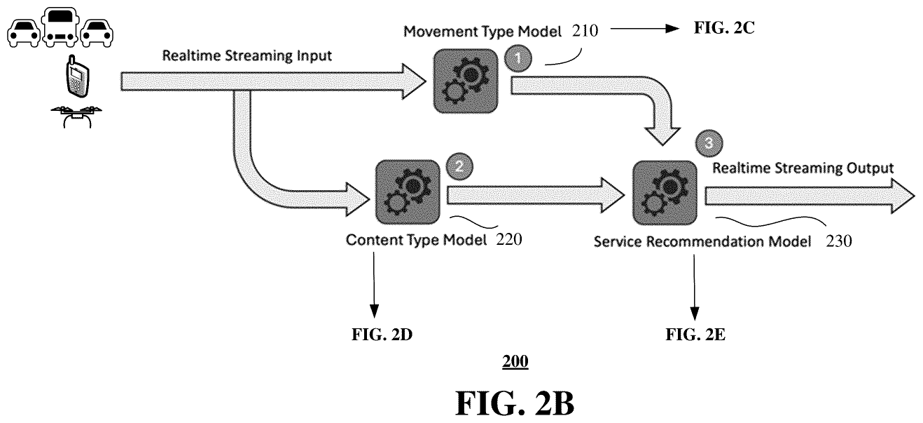

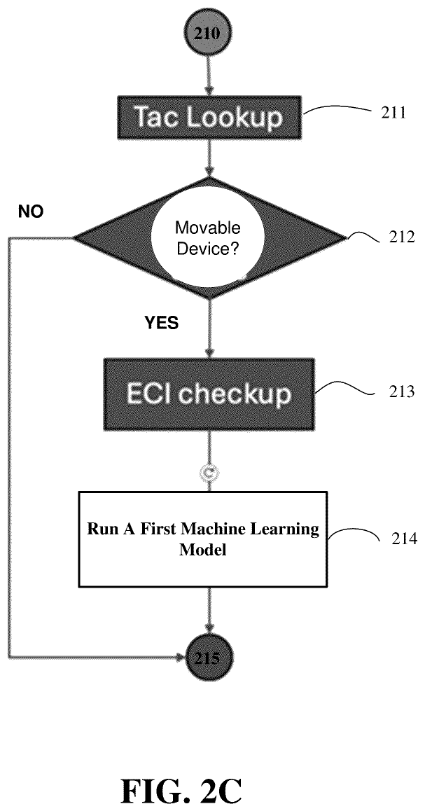

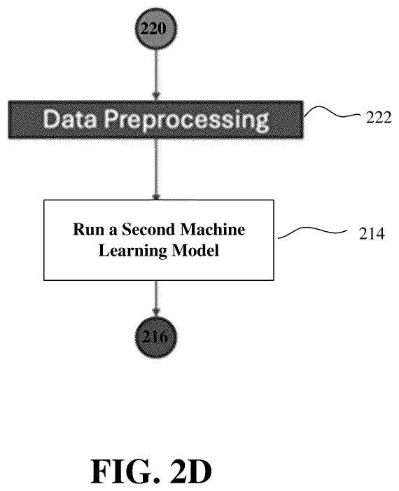

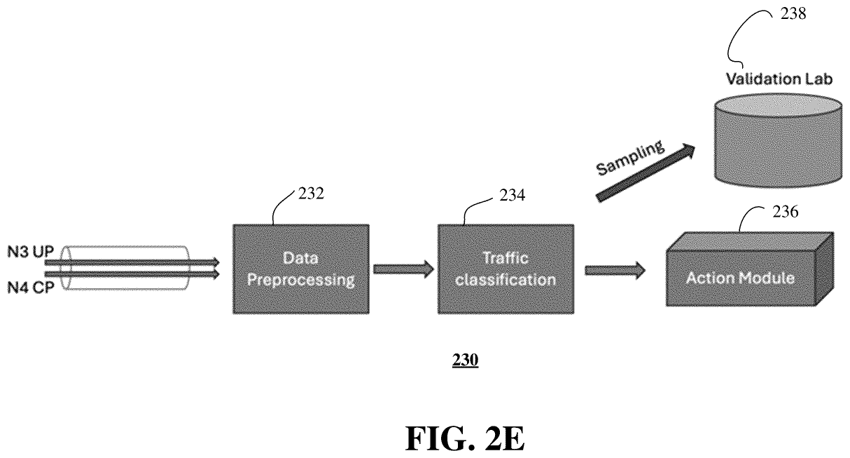

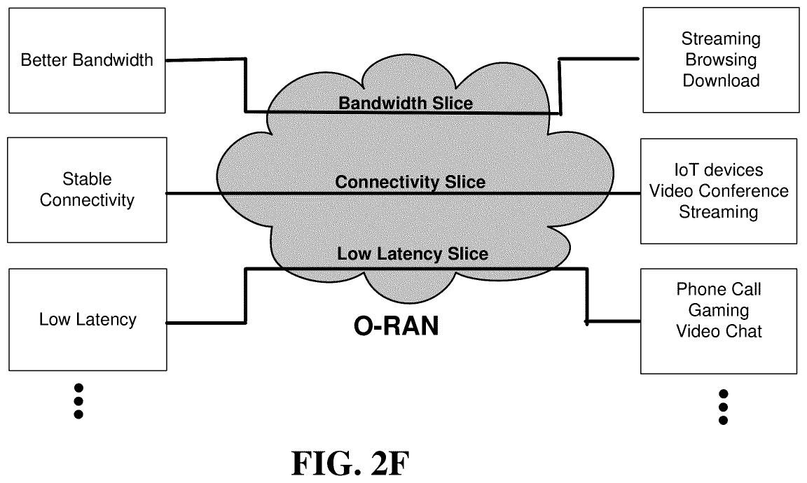

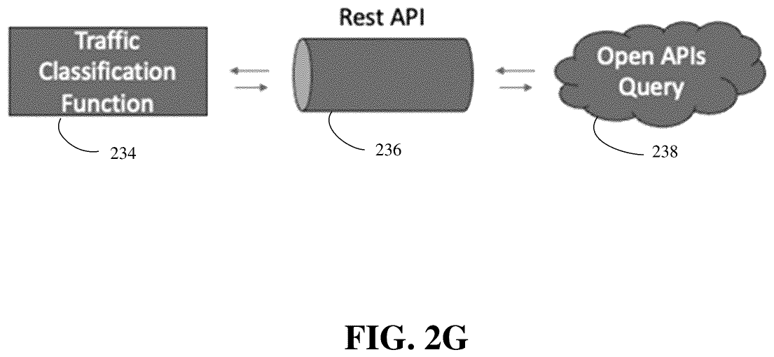

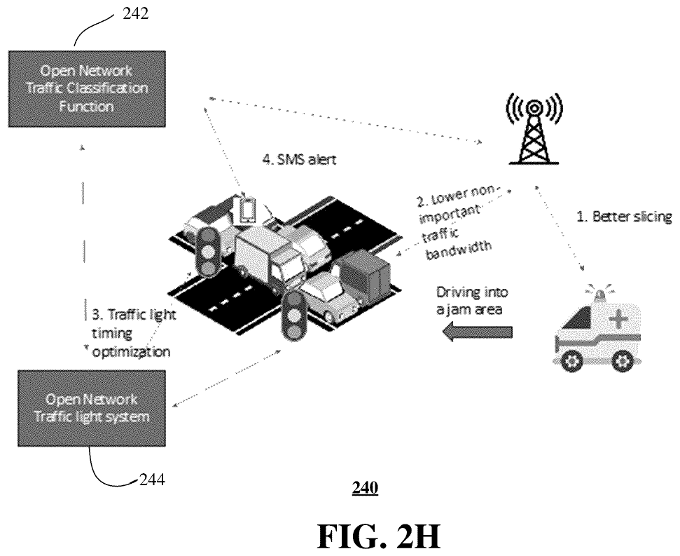

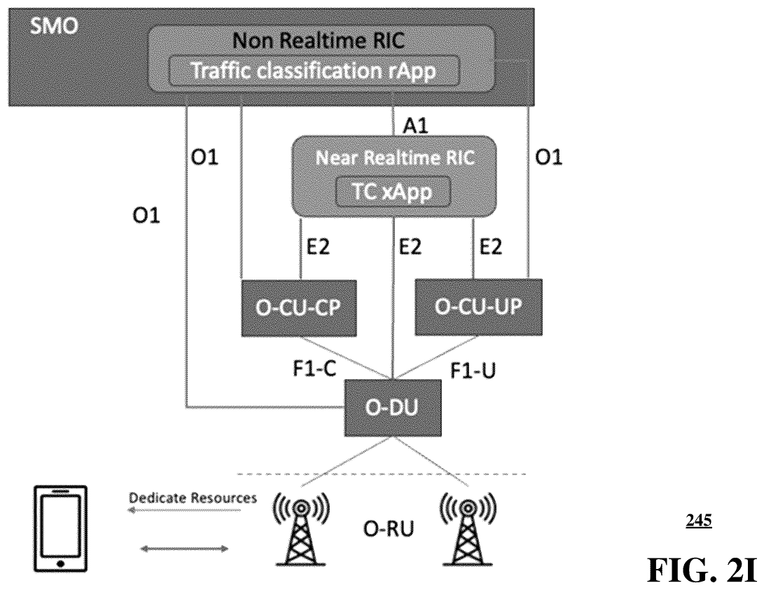

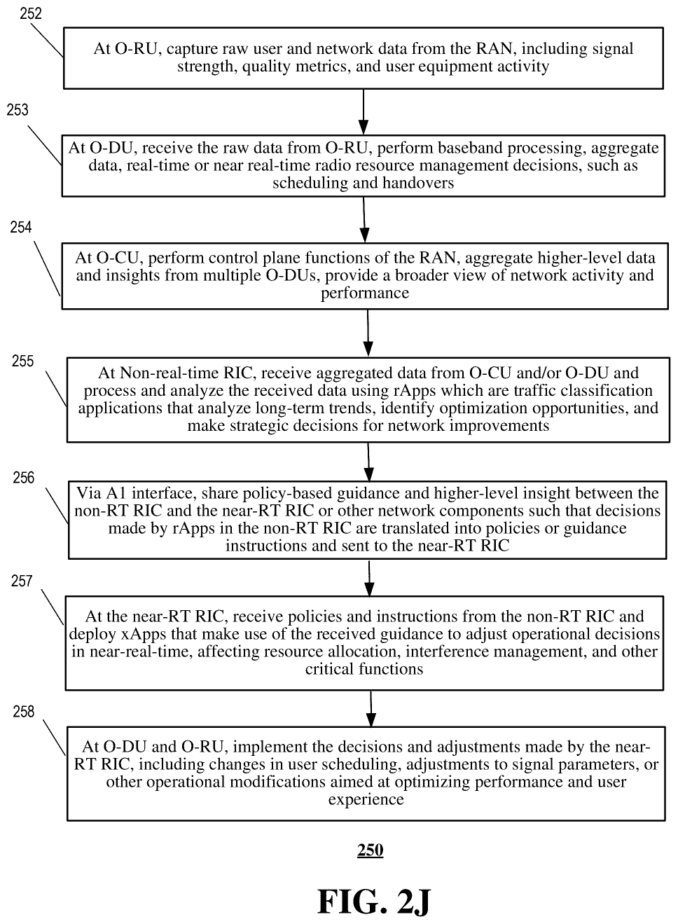

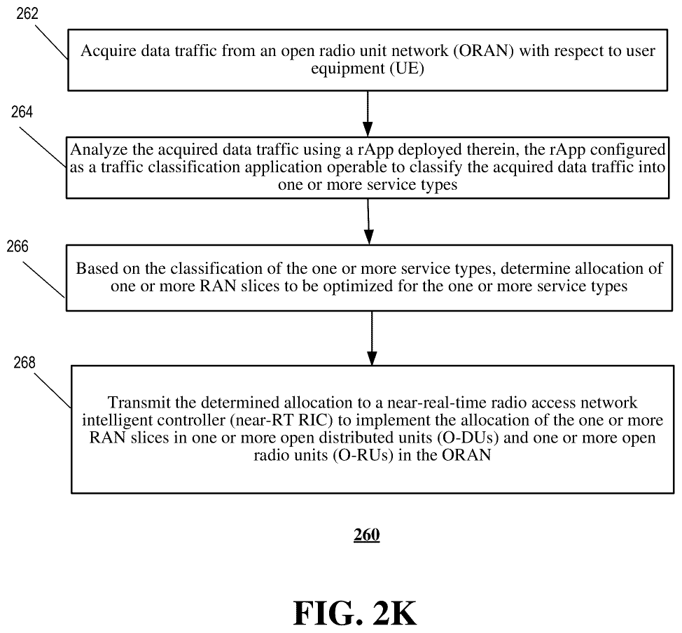

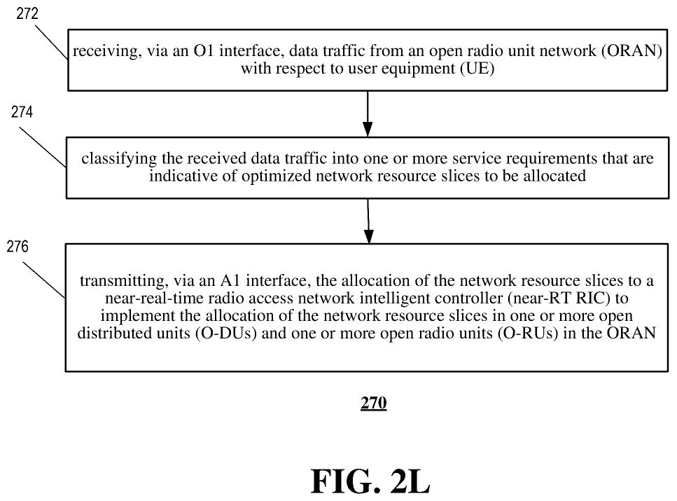

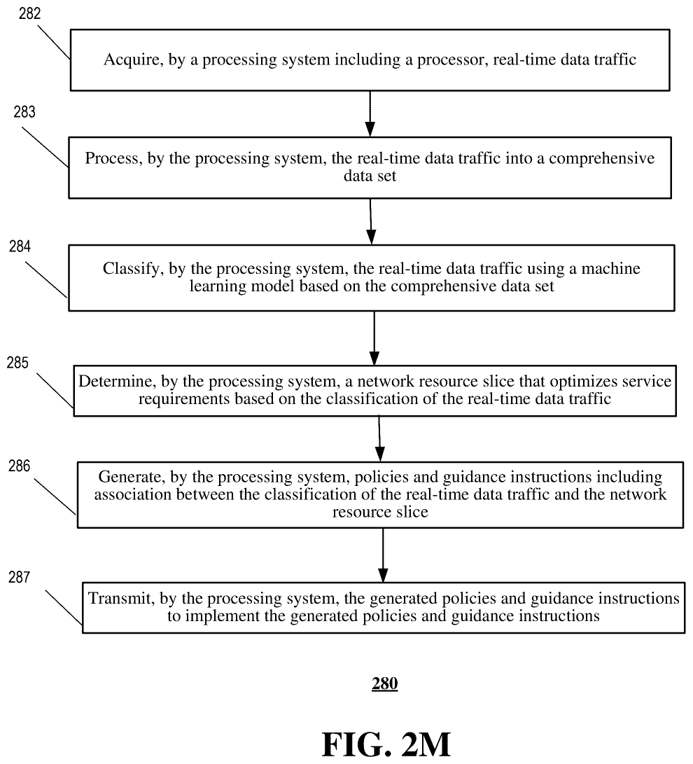

FIG. 2A depicts a non-limiting example of user level traffic type classification. In various embodiments, the user level traffic type classification defines and uses multi-dimensional classification types. By way of example only, the user level traffic type classification includes a content type, a movement type, and a service recommendation type. A first dimension defines the content type, which includes, for instance, video chat, streaming, phone call, gaming, browsing, download, IoT devices, etc. In FIG. 2A, different content types are indicated along a Y-axis. A second dimension defines the movement type, which indicates, for instance, a cell tower handover frequency type, such as no, a few times and many times. In FIG. 2A, the movement type is indicated using shading. Darker shading corresponds to more movement (e.g., a user driving fast and passing more cell towers) and lower shading corresponds to less movement (e.g., a user device being stationary). The movement type can be further associated with a number of cell towers. A third dimension defines a service expectation type, such as better bandwidth, stable connectivity, and low latency. In FIG. 2A, different service expectation types are marked along an x-axis by way of example.

As depicted in FIG. 2A, the first dimension, the second dimension and the third dimension types are correlated and form relationship among themselves. For instance, video chat and gaming require low latency, as opposed to streaming, browsing and download require better bandwidth. For streaming, better bandwidth is beneficial but it may not be always necessary. This is because content providers typically implement their own optimization strategies to ensure a robust network connection for their clients. Therefore, even with average bandwidth, users can still enjoy a smooth streaming experience due to these optimizations.

Another aspect to consider is stability of the connection, especially in cases where a user equipment (UE) is in constant motion at high speeds, as a user is moving in a train or a car. Under these circumstances, the UE might experience disruptions, stalls, and buffering issues during tower handovers, which can negatively impact streaming experience. In those cases, it becomes more critical to have a stable connection. In FIG. 2A, it is depicted by darker shadings indicating fast movement which interacts with different content types and the service expectation type.

To maximize network efficiency, it is desirable to match a right device with right network resources. Therefore, the present disclosure describes that the user level traffic type classification is closely integrated with the network's resource management. The multi-dimensional classification types described above (e.g., content types, movement types, and service recommendations) encompass and address various aspects of user level traffic that allow a network service provider to understand user behavior and allocate appropriate resources effectively.

In various embodiments, after analysis and classification of user level traffic, protocols for use with the user level traffic are considered. Different types of traffic use different protocols to transfer data between the UE and a server. The different type of traffic can be represented using the following exemplary variables from the packets level data:
total Transmission Control Protocol (TCP) up packets
total TCP down packets
total TCP up bytes
total TCP down bytes
number of TCP flows
average frequency between TCP up packets
average frequency between TCP down packets
average TCP up packet bytes size
average TCP down packet bytes size
total User Datagram Protocol (UDP) up packets
total UDP down packets
total UDP up bytes
total UDP down bytes
number of UDP flows
average frequency between UDP up packets
average frequency between UDP down packets
average UDP up packet bytes size
average UDP down packet bytes size
total Domain Name System (DNS) request

Apart from the foregoing variables, device statistics and information may be collected as follows:
International Mobile Subscriber Identity (IMSI)/Mobile Station International Subscriber Directory Number (MSISDN)/International Mobile Equipment Identity (IMEI)
Quality of Service Class Identifier (QCI)/5G Quality of Service Identifier (5QI)
Access Point Name (APN)
Device Type Allocation Code (Device Tac)
E-UTRAN Cell Identifier (ECI)
   Referring to FIGS. 2B through 2E, descriptions of using the foregoing variables and information are provided below.

FIG. 2B is a block diagram illustrating an example, non-limiting embodiment of a user level traffic type classification system 200 in accordance with various aspects described herein. In various embodiments, the system 200 includes a movement type model 210, a content type model 220 and a service recommendation model 230 which receives an input from outputs of the movement type model 210 and the content type model 220. Realtime streaming input is provided to both the movement type model 210 and the content type model 220. Realtime streaming output is generated from the service recommendation model 230. Referring to FIGS. 2C through 2E, the movement type model 210, the content type model 220 and the service recommendation model 230 are described in detail.

FIG. 2C depicts an illustrative embodiment of a movement type machine learning model in accordance with various aspects described herein. In various embodiments, the movement type machine learning model implements the movement type model 210 as depicted in FIG. 2B. The movement type model 210 first checks a type allocation code (TAC) of a target user equipment (UE) which provides traffic (Act 211). The TAC of the target UE is a 8-digit number that identifies a mobile device's manufacturer, model number, and a regulating body that has approved it. TACs are the first eight digits of a device's international mobile equipment identity (IMEI) number. TACs are used to recognize devices that are approved to access network infrastructure by network service providers. One device model may be allocated to a TAC to identify individual mobile devices. Based on a TAC lookup (Act 211), a determination is made as to whether the target UE is a movable device or not (Act 212). If no TAC is located through the TAC lookup (Act 211), the target UE is considered as a not movable device or a stationary device and an output such indication is generated (Act 215). In determining a stationary device, after the TAC lookup returns no result, rule-based classification may be implemented. For instance, specific devices are assigned to a category of immobility during an initial phase by sifting through data. As a result, stationary devices that do not contribute to a subsequent mobility analysis can be eliminated.

When the TAC lookup indicates a movable device (Act 212), then an E-UTRAN Cell Identifier (ECI) checkup follows (Act 213). Incorporating an ECI lookup fosters aggregation of data, allowing for an elevated perspective through cell tower level information. The ECI checkup (Act 213) offers a comprehensive analysis, moving beyond individual cell data to provide a broader understanding of patterns of movement.

As depicted in FIG. 2C, the movement type model 210 utilizes a machine learning technique and runs a first machine learning (ML) model (Act 214). The first ML model is prepared through a training based on input data including ECI numbers, TowerID numbers, and Access Point Numbers (APNs). Output from the first ML model includes no movement, a few movements, and many movements. In some embodiments, predetermined thresholds can be prepared and associated with a few movements and many movements. By way of example only, a few movements can be associated with the target UE moving ten miles in ten minutes, the target UE handing over five times in twenty minutes, etc. Many movements can be associated with the target UE moving more than hundred miles, handing over twenty times, etc. Three categories of movement—no movement, few movements, and many movements—is to distinguish between different types of user activity. These categories help differentiate user activities, for example, differentiating between staying at home, walking or biking, and driving or taking a train. By way of example, a few movements could involve the target UE moving ten miles in ten minutes or the target UE handing over five times in twenty minutes. As another example, many movements could involve the target UE moving more than one hundred miles or handing over twenty times. It is important to note that handovers can occur not only between different cell towers but also between different spectrums or antennas on the same cell tower. This level of movement classification facilitates a straightforward interpretation of the mobility of the target UE, as well as the classification of a stationary device.

Additionally, the coverage range of cell towers varies significantly. For instance, a cell tower in an urban area may cover just a single street, while a tower in a rural area can cover several miles. This variability in coverage is also taken into account when classifying movements.

In various embodiments, the machine learning technique available for handling large datasets and performing classification, regression and ranking can be used to built the first ML model. It is desirable to use the machine learning technique that supports a wide range of problem types and be easily integrated into different programming environments. It is also beneficial to use the machine learning technique that trains the ML model to learn by minimizing a loss function and select a leaf among a tree that minimizes the loss, thereby resulting in a more accurate model. Additionally, the machine learning technique that can output a probability score of each output can enhance accuracy of the result. For instance, the output of “a few times” mobility classification can be output with a probability score of 90%.

FIG. 2D depicts an illustrative embodiment of a content type machine learning model in accordance with various aspects described herein. In various embodiments, the content type machine learning model implements the content type model 220 as depicted in FIG. 2B. The content type model 220 utilizes data gathered at a predetermined time interval (e.g., 30 second interval) and initially collates the above described exemplary variables from the packets level data (Act 222). This data preprocessing stage (Act 222) is vital in preparing the preprocessed data for running a second ML model because the data is structured into a form that can be effectively absorbed by the second ML model. As described above, the second ML model uses the currently available ML technique that handles a large quantity of data, such as the data gathered at the predetermined time interval.

In various embodiments, the second ML model is trained by using the preprocessed input data relating to various variables associated with the data packets, such as TCP packet data (total TCP down packets, total TCP up bytes, total TCP down bytes, total TCP up packet bytes size, total TCP down packet bytes size, average frequency between TCP up packets, average frequency between TCP down packets, a number of TCP flows), UDP packets (total UDP up packets, total UDP down packets, total UDP up bytes, total UDP down bytes, a number of UDP flows, average frequency between DUP up packets, average frequency between UDP down packets, average UDP up packet bytes size, average UDP down packet bytes size, total DNS request). By way of example, TCP may be used for data transmission that requires accuracy, such as emailing, web browsing, etc. TCP uses a checksum for error handling during data transmission. If there is a mismatch between the checksum from a sender and the checksum from a receiver, the packet can be discarded and the TCP makes another request for a complete retransmission of the corrupt packet. Thus, TCP will take its time to ensure reliable and accurate data transmission, which may not be ideal for voice calls or low latency applications. For time sensitive transfers, UDP may be better than TCP as UDP requires little overhead and ensures fast delivery of data, which works better for applications such as VoIP calls, live video streaming, online gaming, etc.

In various embodiments, the most effective methods for capturing and categorizing network traffic may be determined from an application perspective. By understanding the specific requirements and characteristics of different applications, traffic classification can be optimized accordingly. For instance, gaming companies and live chat apps, as well as broadcast streaming services, prefer using UDP for data transmission. These services require data to be sent at regular intervals to remain active, and any delayed packets are no longer useful. The packet sizes for gaming are usually small, containing only coordinates and a few events, whereas 4K streaming requires much larger packets. Furthermore, real-time intensive applications like gaming and remote control need millisecond-level response times, resulting in very small gaps between packets. Furthermore, only real-time intensive applications like gaming and remote control need millisecond-level response times, which results in very small gaps between packets. On the other hand, recorded streaming and transactions such as online shopping may require all messages to be secure and reliable. TCP is preferred in these cases because it ensures that no packets are lost, providing the necessary reliability for these types of services.

In various embodiments, by leveraging these insights, the second ML model can effectively classify network traffic, ensuring efficient and accurate data handling for a wide range of applications. The second ML model outputs are interpreted and content classification types are obtained, such as video chat, streaming, phone call, gaming, etc. (at 216 in FIG. 2D).

Referring back to FIG. 2B, the service recommendation model 230 is constructed based on the outputs of the movement type model 210 and the content type model 220. Inputs to the service recommendation model 230 not only includes the classifications derived from the movement type model 210 and the content type model 220, but also include their respective probability scores. The inclusion of these probability scores provides a measure of confidence associated with each classification, adding an additional layer of depth to the classification analysis. The service recommendation model 230 is trained using a machine learning algorithm, a choice driven by its capabilities for speed, scalability, and high-performance. The ability of machine learning algorithm to handle complex, multi-dimensional data makes it ideal for integrating the outputs of the previous models 210 and 220. This comprehensive modeling approach enables precise prediction of service expectations, serving as a valuable tool for informed decision-making. The resulting classification of the service recommendation model 230 includes, for example, better bandwidth, stable connectivity, or low latency. For instance, the user data traffic is classified as a phone call and involves many movements (e.g., changing cell towers many times), the service recommendation model 220 outputs a resulting classification of requiring a high level of stable connectivity.

Overall, the resulting output of the service recommendation model 230 may be represented by using the chart as depicted in FIG. 2A. The resulting output of the service recommendation model 230 represents scalability that accommodates various different aspects of user data traffic, depending on and varying upon the different content types and the different movement types. Instead of using a rigid, static and fixed result, FIG. 2A demonstrates dynamically optimized and scaled results which can be achieved by using the user level traffic classification system 200. For instance, with respect to each content type, each recommended service type can determined with a varying degree based on another parameter, i.e., the movement type. By classifying the data traffic at the user level, service providers can better understand usage patterns, prioritize network resources, and potentially offer tailored services based on individual user needs.

FIG. 2E is a block diagram illustrating an example, non-limiting embodiment of a system 230 functioning within the communication network of FIG. 1 in accordance with various aspects described herein. The system 230 implements user level traffic type classification in packet data networks for network resources optimization. The system 230 acquires real-time data from both N3 and N4 interfaces, subsequently integrating this information into a comprehensive dataset to prepare for the ML model processes, as described above in connection with FIGS. 2B through 2D. The N3 interface corresponds to an interface between User Plane Function (UPF) and a radio access network, and the N4 interface corresponds to an interface between the UPF and Session Management Function (SMF) in the 5G core network architecture. In the 5G networks, the UPF performs packet routing and forwarding, application detection, per-flow QoS handling, including transport level packet marking for uplink and downlink, traffic usage reporting for billing, and serves as the interconnect point between the mobile infrastructure and the data network. The UPF contains some Deep Packet Inspection (DPI) capabilities and carries both stateful and stateless traffic. Stateful traffic generally includes real-time services, video streaming, web browsing, etc. The UPF also carries stateless traffic regarding size and volume of data (e.g., data from IoT devices) rather than the content.

The N3 interface connects a base station in the RAN to the UPF and user data is conveyed to from the RAN to the UPF for processing via the N3 interface. The UPF sitting from an edge of the network enables low latency and performance requirements of applications, such as low-grade IoT data, a self-driving car, etc. The SMF uses the N4 interface to select the appropriate UPF for a specific user session, to establish, modify and release user plane sessions between the SMF and the UPF, and to configure the selected UPF with the necessary rules and policies for handling the user's data traffic. The UPF can report session-related information and measurement data to the SMF over the N4 interface for charging and monitoring purposes.

In various embodiments, the acquired real-time data from both N3 and N4 interfaces are provided to a data preprocessing stage 232 in order to be used for a traffic classification stage 234. The traffic classification stage 234 includes the user level traffic classification system 200 as described in FIGS. 2B through 2D. As described above, the output from the user level traffic classification system 200 provides the recommended service types varying for the different content types and the different movement types of the user level traffic, as depicted in FIG. 2A. The output from the traffic classification stage 234 is provided to an action stage 236. The action stage 236 is configured to determine network resource allocations based on the output from the traffic classification stage 234, as will be further described below in connection with FIG. 2F. A sample of the output from the traffic classification stage 234 is provided to a validation laboratory to assure the integrity and quality of the output. Concurrently, such a validation process refines and upgrades the ML models as shown in FIGS. 2C-2D to stay abreast of emerging network traffic patterns.

FIG. 2F illustrates an example, non-limiting embodiment of a RAN slicing based on user level traffic classification in accordance with various aspects described herein. Based on the user level traffic classification, the recommended service types are determined and each service type is associated with a RAN slice in the ORAN. As depicted in FIG. 2F, the RAN slice includes, by way of example, a bandwidth slice, a connectivity slice, a low latency slice, etc. The RAN slices are associated with the recommended service types and the user level traffic are associated with corresponding RAN slices in order to facilitate optimized and efficient network resources allocation.

In various embodiments, the bandwidth slice, the connectivity slice, and the low latency slice can be associated with different schedulers assigned thereto, respectively. A first scheduler associated with the bandwidth slice is configured to deal with traffic that requires bandwidth. A second scheduler associated with the connectivity slice is configured to deal with traffic that requires stable connectivity. A third schedule associated with the low latency slice is configured to deal with traffic that requires low latency. Additionally, or alternatively, a certain fraction of the available RAN resource can be reserved for premium users or other high priority safety (e.g., first responders, public safety, etc.).

FIG. 2G depicts an illustrative embodiment of utilizing open standards in a traffic classification system in accordance with various aspects described herein. In various embodiments, a traffic classification system such as the traffic classification system 234 as depicted in FIG. 2E may utilize and build upon open standards, which facilitates a compatibility of the traffic classification system with various network devices. As one example, the traffic classification system 234 work with open Application Program Interfaces (APIs). One example of open APIs for use with the traffic classification system 234 is an Representational State Transfer (REST) API 236. The REST API 236 is a specific type of API that adheres to constraints of the REST architecture and uses HTTP requests to interacts with data. Traditional APIs can use various different protocols. The traffic classification system 234 can send and receive open APIs queries 238 via the REST API 236. Cloud based architecture allows easy expansion. Robust authorization protocols can be implemented to protect the access for API.

FIG. 2H depicts a non-limiting example of a traffic classification system as shown in FIG. 2G in accordance with various aspects described herein. As described in connection with FIG. 2G, the traffic classification system utilizing the open standards can have many use cases. FIG. 2H illustrates one use case. There is a traffic jam area having ongoing traffic congestion situations. When an ambulance is approaching the congested area, an important medical IoT device is detected. The ambulance is classified as a prioritized class and associated with a best RAN slice by collaborating with a network management function, as shown with “1. Better Slicing.” If needed, bandwidth may be adjusted to lower bandwidth of other non-important traffic bandwidth, as shown with “2. Lower non-important traffic bandwidth.” To reduce the congestion, a request can be sent to a traffic light system located at an intersection, using an open API, to adjust a timing for traffic light to let the ambulance pass the intersection. See “3. Traffic light timing optimization.” As another example of using the open standards, the traffic classification system sends a SMS alert indicating that the ambulance is approaching to users nearby, as shown as “4. SMS alert” in FIG. 2H.

FIG. 2I is a block diagram illustrating an example, non-limiting embodiment of an open radio access network (ORAN) functioning within the communication network of FIG. 1 in accordance with various aspects described herein. In various embodiments, the integration of RAN Intelligent Controller (RIC) in O-RAN (Open Radio Access Networks) architectures offers an avenue to refine and operationalize the traffic classification system described. The RIC in O-RAN architectures is designed to optimize radio resources and RAN performance in real-time. By integrating the traffic classification system with the RIC, service providers can achieve dynamic traffic management based on user-level traffic type classification. This integration allows real-time traffic steering as the RIC can use the insights from traffic classification to dynamically steer traffic, ensure optimal resource allocation for different types of usage (streaming, browsing, gaming, calls, etc.) and enhance user experience. The integration with the RIC further enables adaptive network slicing. More specifically, with the precise traffic classification, the RIC can facilitate more effective network slicing, creating dedicated network slices for specific service types or user groups. This may lead to better QoS (Quality of Service) management and resource utilization. The integration of the traffic classification system with the RIC in the ORAN may be used to set new standards in the network optimization, paving the way for more intelligent, user-centric network management in the era of 5G/6G connectivity and/or next generation mobility standards.

Referring back to FIG. 2I, a user equipment is communicatively connected to a radio unit of the ORAN (Open Radio Unit: O-RU). The O-RU is responsible for the radio frequency (RF) functions and initially captures raw user and network data from the radio environment. This includes signal strength, quality metrics, and user equipment (UE) activity. The O-RU is connected to a distributed unit of the ORAN (Open Distributed Unit: O-DU). The O-DU (Open Distributed Unit) receives the raw data from the O-RU. It performs the baseband processing and further aggregates this data. The O-DU is responsible for real-time, or near-real-time, radio resource management decisions, such as scheduling and handovers.

O-CU (Open Central Unit) connects to the O-DU and is responsible for the control plane functions of the RAN. The O-CU can aggregate higher-level data and insights from multiple O-DUs, providing a broader view of network activity and performance. The aggregated data from the O-CU (and possibly directly from the O-DU for certain metrics) is then transferred to a non-real time RIC. This transfer can occur over various interfaces, including an O1 interface for fault and configuration management data and an O2 interface for orchestration and management data.

A central unit control plane of the ORAN (O-CU-CP) and a central unit user plane of the ORAN (O-CU-UP) can be collocated with a User Plane Function (UPF) and a Multi-Edge Computing (MEC) platform and application at an edge site. This configuration allows a local breakout of user traffic at a distributed edge site that is close to a user equipment, thereby facilitating a low-latency service access. This configuration further allows user traffic to be handled locally at the edge site without forwarding user traffic to a backhaul network. When a CU, UPF, and MEC are collocated together, on the same network functions virtualization infrastructure (NFVI) layer, the MEC platform and applications can use a network quality status for the Radio Network Information Service (RNIS) through API exchange within the platform.

Software-defined RAN (SD-RAN) is 3GPP compliant software-defined RAN that is consistent with the O-RAN architecture. The SD-RAN configurations include a near real-time RAN intelligent controller (near RT-RIC). The near-RT RIC is connected to the central unit control plane of the ORAN (O-CU-CP) and the central unit user plane of the ORAN (O-CU-UP) via an E2 interface. The E2 interface supports network functions that allow southbound nodes to set up the E2 interface and register a list of applications that the southbound nodes support. The E2 interface further allows xApps running in the near-RT RIC to subscribe for events from the southbound nodes, such as prescribing an action to execute upon encountering an event where the action can be to report the event, report, and wait for further control instructions from xApps, or executing a policy. By way of example, the E2 interface supports and facilitates traffic steering, QoS-based resource optimization, massive MIMO optimization, RAN analytics information exposure, general reporting, etc. with respect to cellular networks.

In various embodiments, the near-RT RIC is a suite of software applications to enable software-defined network functionalities in O-RAN networks. The near-RT RIC handles and manages all RAN operation and optimization procedure such as radio connection management, mobility management, Quality of Service (QoS) management, edge services, radio resource management, policy optimization in RAN, etc. The near-RT RIC also handles per-UE controller load balancing and resource block management and allows for on-boarding of third party control applications as depicted in FIG. 2I (i.e., Traffic Control xApps). Furthermore, the near-RT RIC manages a database (e.g., Network Information Base (NIB)) which captures the near real-time state of the underlying network.

As depicted in FIG. 2I, the near-RT RIC is connected, via an interface A1, to a Service Management and Orchestration (SMO) platform in the O-RAN. The SMO platform is an automation platform for O-RAN and includes a non-real-time radio intelligent controller (Non-RT RIC). The Non-RT RIC handles service and policy management and operates with the near RT-RIC to execute real-time control functions via the interface A1. Network management applications in the Non-RT RIC receive highly reliable data over the O1 interface. In some embodiments, network operators deploy core algorithm of the Non-RT RIC in order to modify the RAN behaviors. The SMO is enabled to do management functions, such as provisioning management services, fault supervision management services, performance assurance management services, file management services, communication surveillance, startup and registration management services for physical network functions (PNFs), etc.

In various embodiments, the near-RT RIC supports an xApp which is an application that needs to execute at timescales of less than a second. Applications that need to execute at timescales of greater than a second are referred to as rApps and the non-RT RIC uses rApps to analyze various information and generate policies. The near-RT RIC handles xApps, such as Mobility Management, and the non-RT RIC handles the high-level orchestration functions and provides policies to the near-RT RIC over the A1 interface.

In various embodiments, utilizing artificial intelligence (AI) and machine learning, the near-RT RIC dynamically optimizes network resources in real-time, ensuring optimal allocation based on user demand and service requirements. This capability is crucial for supporting the high data rates, low latency, and massive connectivity promised by 5G. Furthermore, the near-RT RIC enhances the network's ability to adapt to changing conditions, such as mobility patterns and varying service demands, ensuring a consistent and high-quality user experience. For instance, reported or discovered transmission delays or packet loss, network congestion, network availability information, etc. can be analyzed by using the AI/ML techniques.

In various embodiments, a real-time scheduler running in the O-DU receives high-level directives from the near real-time scheduler running in the O-CU-UP. These directives make dual transmission, handoff, and interference decisions on a per-slice basis. A RAN slicing control application is responsible for the macro-scheduling decision by allocating resources among a set of slices. Control decisions may be implemented by software modules and are not locked into an underlying system.

In various embodiments, the near-RT RIC's intelligent resource management capabilities are pivotal in efficiently allocating resources across different slices, ensuring that each slice meets its unique performance criteria without interfering with others. This enables a diverse range of services, from ultra-reliable low-latency communications for critical applications to high-throughput data services for multimedia consumption, all within the same network infrastructure. Moreover, the near-RT RIC's adaptability and intelligence lay the groundwork for future innovations in 5G and beyond, including seamless integration with IoT devices, support for augmented and virtual reality applications, and the potential for even more personalized and dynamic network services. The near-RT RIC realizes the full potential of 5G networks, driving advancements in network performance, efficiency, and the enablement of cutting-edge services. Based on packets and bytes signatures, an internet service provider (ISP) is informed, in near real-time, capturing packet-level information by subscribers using its network. In some embodiments, ISP's existing use of probes may be relied on, which are typically used to monitor network health, troubleshoot problems, etc., and where many, if not all, ISPs already deploy. Traffic type patterns are distinct and may not be significantly affected by network noise.

FIG. 2J depicts an illustrative embodiment of a method 250 in accordance with various aspects described herein. In various embodiments, the method 250 is directed to implementing user level traffic classification and network resource allocation based in the ORAN architecture as depicted in FIG. 2I. The method 250 includes at O-RU, capturing raw user and network data from the RAN, including signal strength, quality metrics, and user equipment activity (Step 252), at O-DU, receive the raw data from O-RU, perform baseband processing, aggregate data, real-time or near real-time radio resource management decisions, such as scheduling and handovers (Step 253), at O-CU, perform control plane functions of the RAN, and aggregate higher-level data and insights from multiple O-DUs, provide a broader view of network activity and performance (Step 254).

In various embodiments, the method 250 further includes, at non-RT RIC, receive the aggregated data from O-CU and/or O-DU, process and analyze the received data using deployed rApps (Step 255). The deployed rApps serve as the traffic classification applications which can analyze long-term trends, identify optimization opportunities, and make strategic decisions for network improvements (Step 255). The method 250 also includes, at the A1 interface, sharing policy-based guidance and higher-level insight between the non-RT RIC and the near-RT RIC or other network components. Many rules facilitates the traffic classification performed in the ORAN. The method 250 further includes that via the A1 interface, the quick decisions made by rApps in the non-RT RIC are translated into policies or guidance instructions and sent to the near-RT RIC (Step 256).

In various embodiments, the method 250 includes, at the near-RT RIC, receiving policies and instructions from the non-RT RIC via the A1 interface and deploying xApps that make use of this guidance to adjust operational decisions in near-real-time, affecting resource allocation, interference management, and other critical functions (Step 257). The method 250 also includes, at O-DU and subsequently O-RU, implementing the decisions and adjustments made by the near-RT RIC. This implementation may involve changes in user scheduling, adjustments to signal parameters, or other operational modifications aimed at optimizing performance and user experience. As a result, the method 250 may achieve improved network performance. For instance, the adjustments made at the O-DU and O-RU levels lead to direct improvements in network performance. In addition, users may experience higher data speeds, improved connectivity, and reduced latency.

FIG. 2K depicts an illustrative embodiment of a method 260 in accordance with various aspects described herein. In various embodiments, the method 260 includes acquiring data traffic from an open radio unit network (ORAN) with respect to user equipment (UE)(Step 262); analyzing the acquired data traffic using a rApp deployed therein, the rApp configured as a traffic classification application operable to classify the acquired data traffic into one or more service types (Step 264); based on the classification of the one or more service types, determining allocation of one or more RAN slices to be optimized for the one or more service types (Step 266); and transmitting the determined allocation to a near-real-time radio access network intelligent controller (near-RT RIC) to implement the allocation of the one or more RAN slices in one or more open distributed units (O-DUs) and one or more open radio units (O-RUs) in the ORAN (Step 268).

In various embodiments, the traffic classification application is further operable to classify the acquired data traffic into a content type based on a plurality of data packet variables, wherein the content type includes one of video chat, streaming, phone call, gaming, browsing, download, and IoT devices. The traffic classification application is further operable to classify the acquired data traffic into a movement type based on a plurality of user equipment related variables and preconfigured rules defining one or more stationary devices, wherein the movement type includes no movement, a medium level of movement, and a frequent level of movement greater than the medium level of movement. The traffic classification application is further configured to be a machine learning model and operable to classify the acquired data traffic into the one or more service types by using the classified content type and the classified movement type as inputs to the machine learning model, wherein the one or more service types are outputs of the machine learning model.

In various embodiments, the plurality of data packet variables comprises a set of Transmission Control Protocol (TCP) data packet related variables, a set of User Datagram Protocol (UDP) packet data packet related variables, a total domain name system request, or a combination thereof. The plurality of user equipment related variables further comprises International Mobile Subscriber Identity (IMSI), Mobile Station International Subscriber Directory Number (MSISDN), International Mobile Equipment Identity (IMEI), Quality of Service Class Identifier (QCI), 5G Quality of Service Identifier (5QI), Access Point Name (APN), Device Type Allocation Code (Device Tac), E-UTRAN Cell Identifier (ECI) or a combination thereof. The traffic classification application is further operable to classify the acquired data traffic into the movement type by eliminating the one or more stationary devices based on the preconfigured rules. The one or more service types further comprise a bandwidth focus, a connectivity focus, and a low latency focus.

FIG. 2L depicts an illustrative embodiment of a method 270 in accordance with various aspects described herein. In various embodiments, the method 270 includes receiving, via an O1 interface, data traffic from an open radio unit network (ORAN) with respect to user equipment (UE) (Step 272); classifying the received data traffic into one or more service requirements that are indicative of optimized network resource slices to be allocated (Step 274); and transmitting, via an A1 interface, the allocation of the network resource slices to a near-real-time radio access network intelligent controller (near-RT RIC) to implement the allocation of the network resource slices in one or more open distributed units (O-DUs) and one or more open radio units (O-RUs) in the ORAN (Step 276).

In various embodiments, the classifying the received data traffic further comprise classifying the received data traffic using a plurality of machine language models. The classifying the acquired data traffic further comprise classifying the received data traffic based on a first set of variables, wherein the first set of variables represents a content type of user level traffic from the UE. The classifying the received data traffic further comprise classifying the received data traffic based on a second set of variables, wherein the second set of variables represents a movement type of user level traffic from the UE. The classifying the received data traffic further comprise determining the one or more service requirements based on the content type and the movement type of the user level traffic from the UE. The method 270 further comprise enabling the near-RT RIC to deploy xApps that adjust operational decisions in near-real time, based on the allocation of the network resource slices, wherein the adjustment of the operational decisions results in changes in scheduling of the UE in the one or more open distributed units (O-DUs) and one or more open radio units (O-RUs) in the ORAN.

FIG. 2M depicts an illustrative embodiment of a method 280 in accordance with various aspects described herein. In various embodiments, the method 280 includes acquiring, by a processing system including a processor, real-time data traffic (Step 282); processing, by the processing system, the real-time data traffic into a comprehensive data set (Step 283); classifying, by the processing system, the real-time data traffic using a machine learning model based on the comprehensive data set (Step 284); determining, by the processing system, a network resource slice that optimizes service requirements based on the classification of the real-time data traffic (Step 285); generating, by the processing system, policies and guidance instructions including association between the classification of the real-time data traffic and the network resource slice (Step 286); and transmitting, by the processing system, the generated policies and guidance instructions to implement the generated policies and guidance instructions (Step 287).

In various embodiments, the method 280 includes deploying, by the processing system, rApps that translate the determination of the network resource slice that optimizes the service requirements into the policies and guidance instructions. The transmitting further comprises transmitting the generated policies and guidance instructions to a near-real-time RIC, and the implementing further comprises changing user scheduling and adjusting signal parameters relating to the network resource slice. The transmitting further comprises transmitting the generated policies and guidance instructions to implement the generated policies and guidance instructions in near-real-time in distributed units and radio units. The classifying the real-time data traffic further comprise classifying the real-time data traffic based on a first set of variables and a second set of variables, wherein the first set of variables represents a content type of user level traffic from the UE and the second set of variables represents a movement type of user level traffic from the UE. The method 280 further includes determining, by the processing system, the service requirements based on the content type and the movement type of the user level traffic from the UE.

While for purposes of simplicity of explanation, the respective processes are shown and described as a series of blocks in FIGS. 2J-2M, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

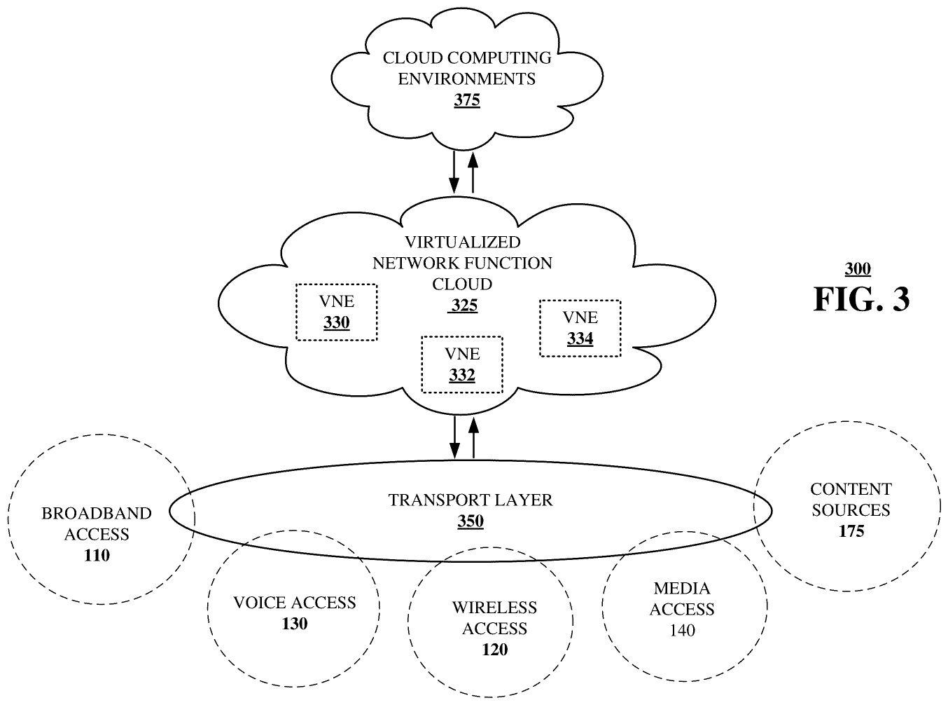

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of systems 200, 230, 245 and methods 250, 260, 270 and 280 presented in FIGS. 1, 2B, 2E, 2I through 2M and 3. For example, virtualized communication network 300 can facilitate in whole or in part systems and methods facilitating user level traffic type classification in packet data networks for network resource optimization in ORAN.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

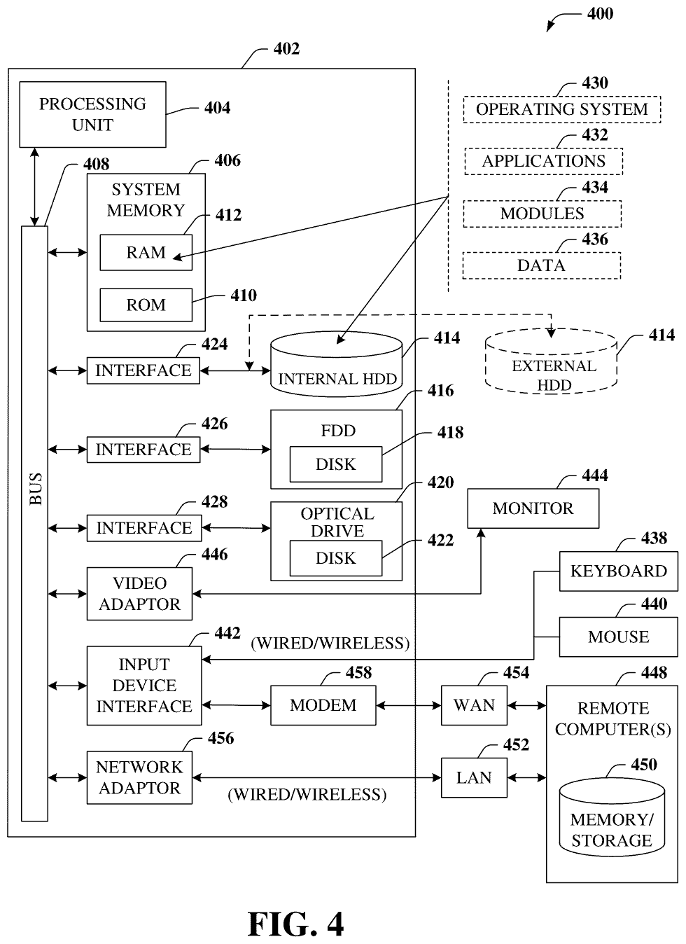

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part systems and methods facilitating user level traffic type classification in packet data networks for network resource optimization in ORAN.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

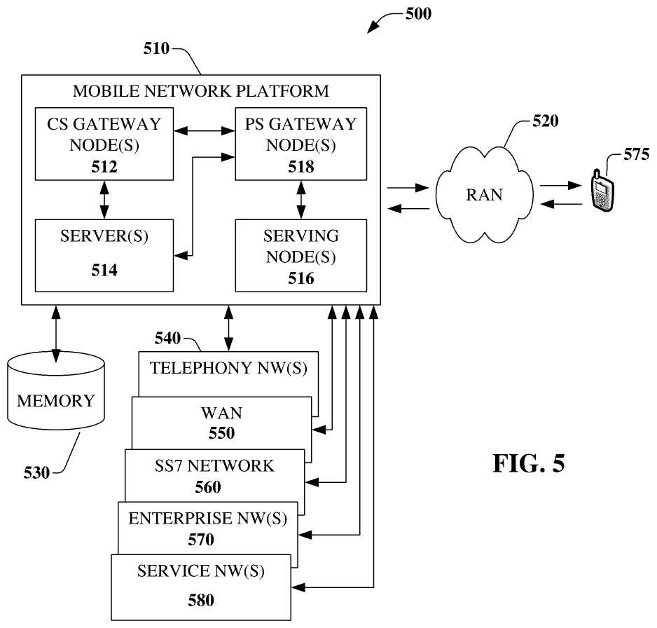

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part systems and methods facilitating user level traffic type classification in packet data networks for network resource optimization in ORAN. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

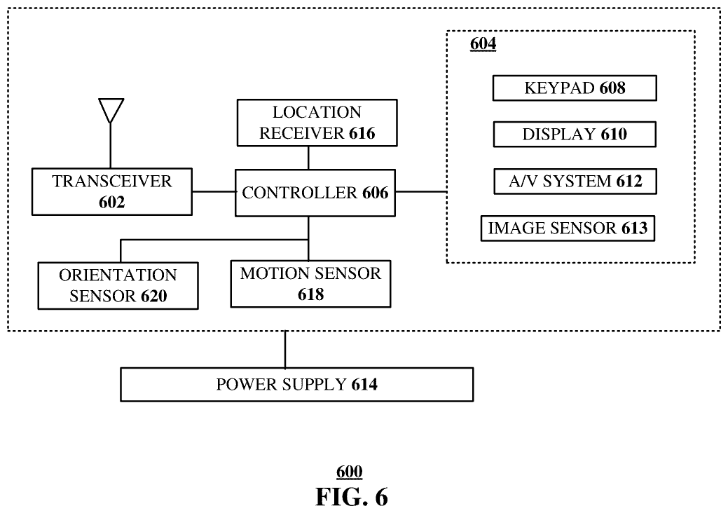

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part systems and methods facilitating user level traffic type classification in packet data networks for network resource optimization in ORAN.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system of a non-real-time radio access network intelligent controller (non-RT RIC) in an open radio access network (ORAN), the processing system including a processor; and
a memory that stores executable instructions that, when executed by the processing system, facilitate performance of operations, the operations comprising:
acquiring data traffic from the ORAN with respect to user equipment (UE) resulting in acquired data traffic;
analyzing the acquired data traffic using a rApp deployed therein, the rApp configured as a traffic classification application operable to classify the acquired data traffic into one or more service types;
based on the classification of the one or more service types, determining allocation of one or more RAN slices to be optimized for the one or more service types; and
transmitting the determined allocation to a near-real-time radio access network intelligent controller (near-RT RIC) to implement the allocation of the one or more RAN slices in one or more open distributed units (O-DUs) and one or more open radio units (O-RUs) in the ORAN.

2. The device of claim 1, wherein the traffic classification application is further operable to classify the acquired data traffic into a content type based on a plurality of data packet variables, wherein the content type includes one of video chat, streaming, phone call, gaming, browsing, download, and IoT devices.

3. The device of claim 2, wherein the traffic classification application is further operable to classify the acquired data traffic into a movement type based on a plurality of user equipment related variables and preconfigured rules defining one or more stationary devices, wherein the movement type includes no movement, a medium level of movement, and a high level of movement being more frequent than the medium level of movement within a preset time duration.

4. The device of claim 3, wherein the traffic classification application is further configured to be a machine learning model and operable to classify the acquired data traffic into the one or more service types by using the classified content type and the classified movement type as inputs to the machine learning model, wherein the one or more service types are outputs of the machine learning model.

5. The device of claim 2, wherein the plurality of data packet variables comprises a set of Transmission Control Protocol (TCP) data packet related variables, a set of User Datagram Protocol (UDP) packet data packet related variables, a total domain name system request, or a combination thereof.

6. The device of claim 3, wherein the plurality of user equipment related variables further comprises International Mobile Subscriber Identity (IMSI), Mobile Station International Subscriber Directory Number (MSISDN), International Mobile Equipment Identity (IMEI), Quality of Service Class Identifier (QCI), 5G Quality of Service Identifier (5QI), Access Point Name (APN), Device Type Allocation Code (Device Tac), E-UTRAN Cell Identifier (ECI) or a combination thereof.

7. The device of claim 3, wherein the traffic classification application is further operable to classify the acquired data traffic into the movement type by eliminating the one or more stationary devices based on the preconfigured rules.

8. The device of claim 5, wherein the one or more service types further comprise a bandwidth focus, a connectivity focus, and a low latency focus.

9. A non-transitory machine-readable medium, comprising executable instructions that, when executed by a processing system including a processor of an open radio access network, facilitate performance of operations, the operations comprising:
receiving, via an O1 interface, data traffic from an open radio unit network (ORAN) with respect to user equipment (UE);
classifying the received data traffic into one or more service requirements that are indicative of optimized network resource slices to be allocated; and
transmitting, via an A1 interface, the allocation of the network resource slices to a near-real-time radio access network intelligent controller (near-RT RIC) to implement the allocation of the network resource slices in one or more open distributed units (O-DUs) and one or more open radio units (O-RUs) in the ORAN.

10. The non-transitory machine-readable medium of claim 9, wherein the classifying the received data traffic further comprise classifying the received data traffic using a plurality of machine language models.

11. The non-transitory machine-readable medium of claim 9, wherein the classifying the received data traffic further comprise classifying the received data traffic based on a first set of variables, wherein the first set of variables represents a content type of user level traffic from the UE.

12. The non-transitory machine-readable medium of claim 11, wherein the classifying the received data traffic further comprise classifying the received data traffic based on a second set of variables, wherein the second set of variables represents a movement type of user level traffic from the UE.

13. The non-transitory machine-readable medium of claim 12, wherein the classifying the received data traffic further comprise determining the one or more service requirements based on the content type and the movement type of the user level traffic from the UE.

14. The non-transitory machine-readable medium of claim 9, wherein the operations further comprise enabling the near-RT RIC to deploy xApps that adjust operational decisions in near-real time, based on the allocation of the network resource slices, wherein the adjustment of the operational decisions results in changes in scheduling of the UE in the one or more open distributed units (O-DUs) and one or more open radio units (O-RUs) in the ORAN.

15. A method, comprising:
acquiring, by a processing system including a processor, real-time data traffic;
processing, by the processing system, the real-time data traffic into a comprehensive data set;
classifying, by the processing system, the real-time data traffic using a machine learning model based on the comprehensive data set;
determining, by the processing system, a network resource slice that optimizes service requirements based on the classification of the real-time data traffic;
generating, by the processing system, policies and guidance instructions including association between the classification of the real-time data traffic and the network resource slice; and
transmitting, by the processing system, the generated policies and guidance instructions to a near-real-time radio access network intelligent controller (near-RT RIC) to implement the generated policies and guidance instructions.

16. The method of claim 15, comprising:
deploying, by the processing system, rApps that translate the determination of the network resource slice that optimizes the service requirements into the policies and guidance instructions.

17. The method of claim 15, wherein the implementing further comprises changing user scheduling and adjusting signal parameters relating to the network resource slice.

18. The method of claim 15, wherein the transmitting further comprises transmitting the generated policies and guidance instructions to implement the generated policies and guidance instructions in near-real-time in distributed units and radio units.

19. The method of claim 18, wherein the classifying the real-time data traffic further comprise classifying the real-time data traffic based on a first set of variables and a second set of variables, wherein the first set of variables represents a content type of user level traffic from user equipment (UE) and the second set of variables represents a movement type of user level traffic from the UE.

20. The method of claim 19, further comprising determining, by the processing system, the service requirements based on the content type and the movement type of the user level traffic from the UE.
